(19) United States
(12) Patent Application Publication
(10) Pub. No.: US 2008/0268187 A1
(43) Pub. Date: Oct. 30, 2008

(54) SILICONE ENCASED GLASS OBJECT

(76) Inventor: Roy FIGOVSKY, Tel Aviv (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 11/742,072

(22) Filed: Apr. 30, 2007

(51) Int. Cl. B32B 1/06; B28B 1/14

(52) U.S. Cl. 428/34.1; 264/299

(57) ABSTRACT

Presented herein is a device comprising a breakable object embedded within a flexible housing, wherein, the housing deforms when pressure is applied and returns to the original shape when the pressure is removed; and when the embedded breakable object breaks, the housing contains and supports the fragments of the breakable object such that said fragments maintain the outline and appearance of the breakable object.

### FIELD OF INVENTION

This invention relates generally to a device that is sufficiently resilient to allow a breakable object embedded therein to be broken and sufficiently sturdy to resist damage from the resulting shards, and more specifically to a process of producing such devices.

### BACKGROUND OF THE INVENTION

The origin of the ancient custom calling for the groom to smash a glass under his foot at a Jewish wedding ceremony is unknown. There are many explanations for this glass breaking custom. The most common is that the broken glass is a reminder of the sadness still felt at the destruction of the Temple in Jerusalem. There are many other explanations ranging from the broken glass teaching the bride and groom that marriage is as fragile as glass, to the noise of the breaking glass scaring away demons, to the pieces resulting from the smashed glass representing the time that the couple will remain together.

As traditional as the act of breaking a glass at a Jewish wedding ceremony may be, the same act may also pose some danger to both the participants and the guests. Although the glass is often wrapped in a cloth, nevertheless, there is a hazard posed by fragments left on the floor to be stepped on, and there is a risk that someone may be hit by a flying sliver or fragment of glass.

The custom of breaking a glass is very well known and is a tangible symbol of the wedding ceremony. As such, many couples choose to save the pieces from their broken glass as a memento of their wedding.

There are various options available for turning the glass fragments into such a memento, but, as handling broken glass always poses a risk of injury, so do the currently available options pose the same risk. For example, a glass may be placed inside a cloth bag prior to being smashed and the bag may be saved as the memento; however, if the bag is torn when the glass is smashed, the bag is no longer a suitable option. An alternative is to collect and place the fragments in a container intended for holding these fragments, an option that may be sturdier than the fabric bag but does not eliminate the risk of injury from handling the fragments and slivers of glass.

There is a need for a sturdy and safe method of containing the fragments of glass that is also flexible enough to allow the glass to be smashed, for example, according to the traditions of a Jewish wedding ceremony.

### SUMMARY

Presented herein is a commemorative device that enables a breakable object, such as a glass, to be safely broken and that contains the resulting fragments such that they maintain the outline and appearance of the original object.

A key feature of the present invention is the flexible, resilient, and robust nature of the housing that holds the breakable object. The housing is also sufficiently robust to ensure that once the breakable object is broken, the resulting fragments remain safely contained within the housing. Furthermore, the present invention supports said fragments such that the fragments maintain the outline and appearance of the breakable object prior to its being broken.

Another feature is that the overall appearance and attractive presentation of the present invention provides a memento suitable for display.

Accordingly, a commemorative device of the present invention is provided, said device comprising a breakable object embedded within a flexible housing, wherein, the housing deforms when pressure is applied and returns to substantially the original shape when the pressure is removed; and when the embedded breakable object breaks, the housing contains and supports the fragments of the breakable object such that said fragments maintain the outline and appearance of the breakable object.

Additionally, the breakable object may be glass, and may have at least one fillable cavity.

Additionally, the breakable object may be in the shape of a wine glass.

Additionally, at least a portion of the stem of the wine glass may be removed.

Additionally, the material comprising the housing may include at least one silicone composite.

Additionally, the housing may further comprise a cavity-filling member and the material comprising the cavity-filling member may be more flexible than the material comprising the housing.

Additionally, the housing may be substantially transparent, or may be substantially translucent. Additionally, the housing may further comprise at least one decorative element.

Additionally, the present invention may further comprise a protective cover that encases the housing and the protective cover may have at least one decorative element.

Additionally, the device may further comprise a base on which the housing may be disposed, and the base may have at least one decorative element.

Additionally, a process of producing the present invention may compromise the steps of:
disposing the breakable object within a mold;
preparing the material that comprises the housing;
adding the material that comprises the housing to the mold such that said material engulfs the breakable object;
curing the material that comprises the housing; and
removing the resulting housing with said breakable object embedded therein from the mold.

Additionally the process may further compromise the steps of:
preparing the material that comprises the cavity-filling member;
filling a cavity of the breakable object with the material that comprises the cavity-filling member; and
curing the material that comprises the cavity-filling member;

Additionally the process may further comprise the step of applying a protective cover around the housing.

Additionally the process may further comprise the step of disposing the housing of the commemorative device over a base and affixing the housing thereto.

Additionally the process may further comprise the step of packaging the commemorative device for shipment.

### BRIEF DESCRIPTION OF THE DRAWINGS

The subject matter regarded as the invention will become more clearly understood in light of the ensuing description of embodiments herein, given by way of example and for purposes of illustrative discussion of the present invention only, with reference to the accompanying drawings, wherein

FIG. 1 is a perspective view of a commemorative device with a breakable object in the shape of a wine glass embedded therein, according to an embodiment of the present invention; and

FIG. 2 is a sectional view of the embodiment of FIG. 1.

The drawings together with the description make apparent to those skilled in the art how the invention may be embodied in practice.

No attempt is made to show structural details of the invention in more detail than is necessary for a fundamental understanding of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF SOME EMBODIMENTS OF THE INVENTION

The present invention is a commemorative device comprising a flexible housing with a breakable object embedded therein. The housing is sufficiently resilient to allow said breakable object to break when pressure is applied, as may occur according to the aforementioned glass breaking custom. The housing is also sufficiently robust to ensure that, after the pressure is removed, the housing returns to substantially its original shape and, when, for example, said breakable object is broken, the resulting fragments remain safely contained within the housing. Furthermore, the commemorative device supports said fragments such that the fragments maintain the outline and appearance of the breakable object prior to its being broken. For example, after the groom steps on an embodiment of a commemorative device with a breakable object in the shape of a wine glass embedded therein, according to the glass breaking custom of a Jewish wedding, the wine glass will break and the resulting fragments will remain recognizable as a wine glass.

According to embodiments, the overall appearance and attractive presentation of the present invention may furthermore provide a commemorative device that is suitable for displaying the fragments from the breakable object as a memento, while substantially eliminating the risks of injury posed by the previously discussed display options. Thus, referring to the preceding example, the commemorative device, which now contains glass fragments in the shape of a wine glass, may be set out for display in, for example the home of the bride and groom. In order to enhance the presentation of the present invention, some embodiments of a commemorative device may be placed over a decorative base.

Further presented herein is a process of producing some embodiments of a commemorative device according to the present invention.

An embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It is understood that the phraseology and terminology employed herein is not to be construed as limiting and is for descriptive purpose only.

The principles and uses of the teachings of the present invention may be better understood with reference to the accompanying description, figures and examples.

It is to be understood that the details set forth herein do not construe a limitation to an application of the invention. Furthermore, it is to be understood that the invention can be carried out or practiced in various ways and that the invention can be implemented in embodiments other than the ones outlined in the description below.

It is to be understood that die terms “including”, “comprising”, “consisting” and grammatical variants thereof do not preclude the addition of one or more components, features, steps, integers or groups thereof and that the terms are not to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and novel characteristics of the claimed composition, device or method.

If the specification or claims refer to “an additional” element, that does not preclude there being more than one of the additional element.

It is to be understood that where the claims or specification refer to “a” or “an” element, such reference is not to be construed as there being only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention can be implemented in the testing or practice with methods and materials equivalent or similar to those described herein.

The terms “bottom”, “below”, “top” and “above” as used herein do not necessarily indicate that a “bottom” component is below a “top” component, or that a component that is “below” is indeed “below” another component or that a component that is “above” is indeed “above” another component. As such, directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

Referring now in detail to the drawings, embodiments of a commemorative device 10 according to the present invention comprise at least one breakable object 30 embedded within a flexible housing 20.

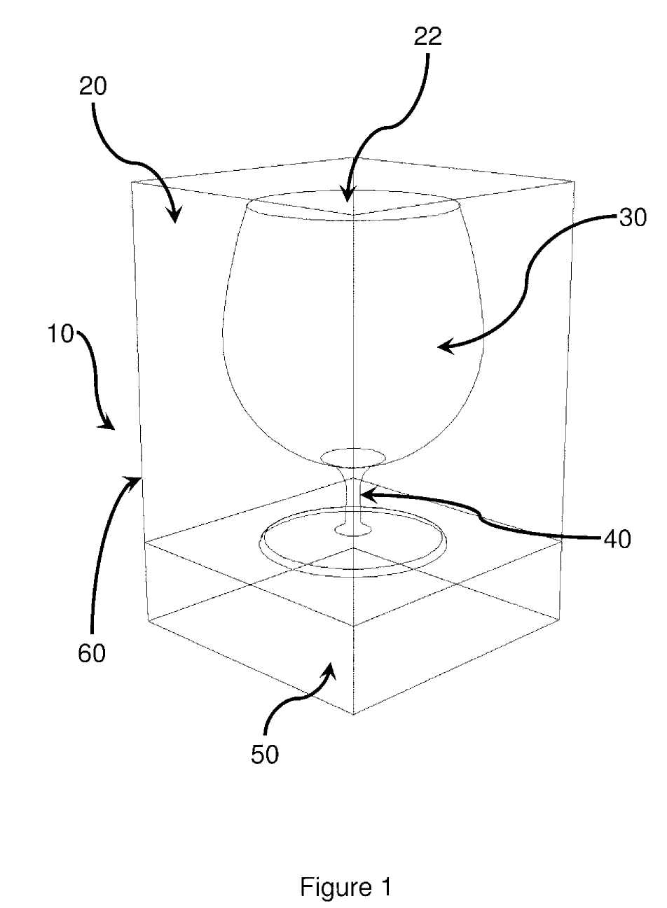

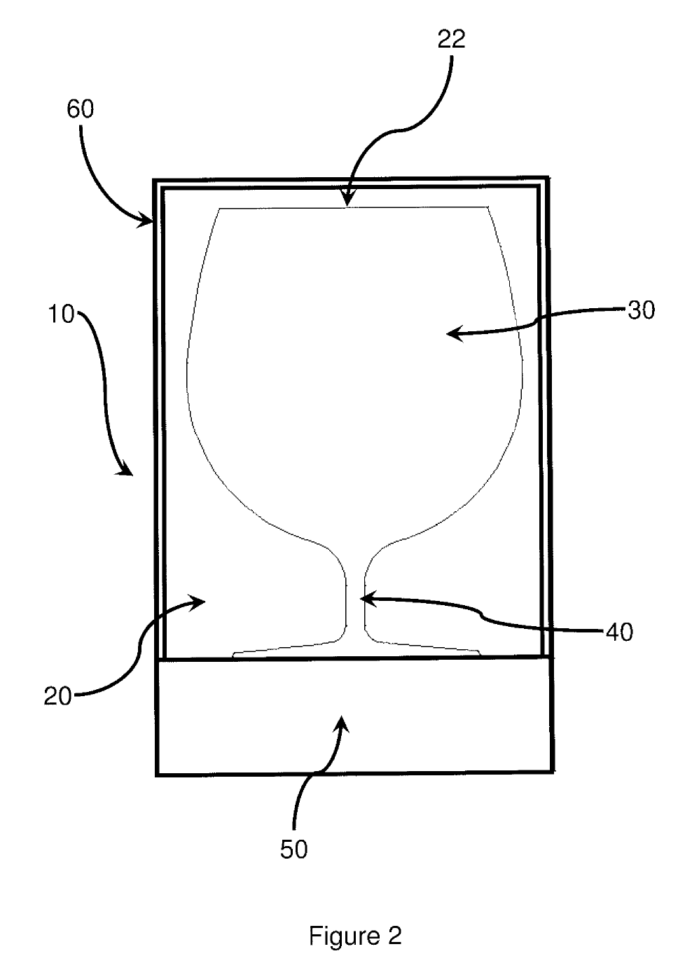

Some embodiments of the present invention may be substantially cubical in shape, as seen in FIGS. 1 and 2; however, other embodiments of the invention may have other shapes, such as a pyramid or cone, without departing from the scope of the invention.

According to embodiments of the present invention, housing 20 of commemorative device 10 is constructed from a resilient, robust material that may be deformed when sufficient pressure is applied and that will return to substantially its original shape when that pressure is removed.

According to some embodiments of the present invention, the material comprising housing 20 may contain at least one silicone composite, such as, for example, a silicone rubber. It is understood, however, that other materials, composites, and constructions could be used in order to provide a robust housing 20 without departing from the scope of the invention.

According to some embodiments of the present invention, the material comprising housing 20 may be substantially transparent and translucent. According to some other embodiments, housing 20 may have some quantity of opacity. According to yet other embodiments, housing 20 may be substantially translucent and not clear. Furthermore, according to some embodiments, housing 20 may have at least one decorative element.

According to embodiments of the present invention, a breakable object 30 is embedded within housing 20. Breakable object 30 may be any type of object that will, for example, fragment, shatter, or break when pressure is applied to housing 20. According to embodiments of the present invention, breakable object 30 may be manufactured according to known in the art techniques, including, for example, molded glass and inflated glass. Additionally, according to some embodiments of the present invention, breakable object 30 has at least one fillable cavity.

According to some embodiments, breakable object 30 is in the shape of, for example, a wine glass, as shown in FIGS. 1 and 2. As a safety precaution, according to such embodiments, at least a portion of the stem 40 of such a wine glass may be removed. Additionally according to such embodiments, in order to complete the shape and outline of a wine glass, a portion of housing 20 approximating the shape and location of, for example, the stem 40 and foot of a wine glass may be left hollow.

It is understood that other materials, constructions, and configurations may also be used for breakable object 30 without departing from the scope of the invention.

According to some embodiments of the present invention, housing 20 may further comprise a cavity-filling member 22. Cavity-filling member 22 may be placed in, for example, at least one cavity of breakable object 30. For example, cavity-filling member 22 may be disposed within the bowl part of a breakable object 30 that is configured into the shape of a wine glass, as described in FIGS. 1 and 2. It should be understood that a cavity-filling member 22 is not necessary to use commemorative device 10 and is merely an optional feature.

According to some embodiments of the present invention, cavity-filling member 22 may be, for example, more flexible than housing 20. This feature may further facilitate the fragmentation, shattering, or breaking of breakable object 30 while also enhancing the ability of housing 20 of commemorative device 10 to maintain the shape of breakable object 30.

According to some embodiments of the present invention, the material comprising cavity-filling member 22 may contain at least one silicone composite. It is understood that other materials, composites, and constructions could be used in older to provide a robust cavity-filling member 22 without departing from the scope of the present invention.

According to some embodiments, a protective cover 60 encases housing 20 of commemorative device 10. Protective cover 60 prevents the exterior surface of housing 20 from becoming marred or scratched. Protective cover 60 may be constructed from any type of flexible plastic material that provides a low tack, protective surface. It should be understood that methods may be used to provide a protective surface over housing 20 without departing from the scope of the present invention. According to some embodiments, protective cover 60 may have at least one decorative element. For example, protective cover 60 may be embellished with engraving, etching, color, pattern, texture, or the like.

According to embodiments of the present invention, commemorative device 10 may further comprise a base 50 on which housing 20 of commemorative device 10 may be disposed. Base 50 may be constructed from, inter alia, wood, metal, plastic, or the like. It is understood that other materials may also be used without departing from the scope of the invention. According to some embodiments of the present invention, base 50 may have at least one decorative element. For example, base 50 may be embellished with at least one of engraving, etching, color, pattern, and texture.

In order to more fully describe the present invention, the following describes a process for producing a commemorative device 10 according to some embodiments of the present invention.

Such a process may compromise the steps of:
preparing the material that comprises cavity-filling member 22;
disposing said material within at least one cavity of breakable object 30;
curing the material that comprises cavity-filling member 22
disposing breakable object 30 with cavity-filling member 22 into a mold;
preparing the material that comprises housing 20;
adding the material that comprises housing 20 to the mold such that said material engulfs breakable object 30;
curing the material that comprises housing 20;
removing the resulting housing 20 with breakable object 30 now embedded therein from the mold; and
a protective cover 60 is placed around housing 20 of commemorative device 10.

According to embodiments of the present invention that are equipped with a base 50, housing 20 of commemorative device 10 may then be disposed over a base 50 and affixed thereto.

Finally, commemorative device 10 may be, for example, packaged for shipment or retail sale.

While the invention has been described with respect to a limited number of embodiments, these should not be construed as limitations on the scope of the invention, but rather as exemplifications of some of the embodiments. Those skilled in the art will envision other possible variations, modifications, and applications that are also within the scope of the invention. Accordingly, the scope of the invention should not be limited by what has thus far been described, but by the appended claims and their legal equivalents. Therefore, it is to be understood that alternatives, modifications, and variations of the present invention are to be construed as being within the scope and spirit of the appended claims.

What is claimed is:

1. A device comprising a breakable object embedded within a flexible housing, wherein,
the housing deforms when pressure is applied and returns to substantially the original shape when the pressure is removed; and
when the embedded breakable object breaks, the housing contains and supports the fragments of the breakable object such that said fragments maintain the outline and appearance of the breakable object.

2. The device of claim 1, wherein the breakable object is glass.

3. The device of claim 1, wherein the breakable object has at least one fillable cavity.

4. The device of claim 2, wherein the breakable object is in the shape of a wine glass.

5. The device of claim 4, wherein at least a portion of the stem of the wine glass is removed.

6. The device of claim 1, wherein the material comprising the housing includes at least one silicone composite.

7. The device of claim 1, wherein the housing further comprises a cavity-filling member.

8. The device of claim 7, wherein the material comprising the cavity-filling member is more flexible than the material comprising the housing.

9. The device of claim 1, further comprising a protective cover that encases the housing.

10. The device of claim 9, wherein the protective cover has at least one decorative element.

11. The device of claim 1, further comprising a base on which the housing may be disposed.

12. The device of claim 1, wherein the housing is substantially transparent.

13. The device of claim 1, wherein the housing is substantially translucent.

14. The device of claim 1, wherein the housing further comprises at least one decorative element.

15. The device of claim 11, wherein the base has at least one decorative element.

16. A process of producing the device of claim 1, said process compromising the steps of:
disposing the breakable object within a mold;
preparing the material that comprises the housing;
adding the material that comprises the housing to the mold such that said material engulfs the breakable object;
curing the material that comprises the housing; and
removing the resulting housing with said breakable object embedded therein from the mold.

17. The process of claim 16, further comprising the steps of:
preparing the material that comprises the cavity-filling member;
filling a cavity of the breakable object with the material that comprises the cavity-filling member; and
curing the material that comprises the cavity-filling member.

18. The process of claim 16, further comprising the step of applying a protective cover around the housing.

19. The process of claim 16, further comprising the step of disposing the housing of the commemorative device over a base and affixing the housing thereto.

20. The process of claim 16, further comprising the step of packaging the commemorative device for shipment.
